(19) United States
(12) Patent Application Publication
(10) Pub. No.: US 2013/0048283 A1
(43) Pub. Date: Feb. 28, 2013

(54) Subterranean Reservoir Treatment Method

(71) Applicants: Sergey Mikhailovich Makarychev-Mikhailov, St. Petersburg (RU); Vadim Kamil'evich Khlestkin, Novosibirsk (RU)

(72) Inventors: Sergey Mikhailovich Makarychev-Mikhailov, St. Petersburg (RU); Vadim Kamil'evich Khlestkin, Novosibirsk (RU)

(73) Assignee: Schlumberger Technology Corporation

(21) Appl. No.: 13/642,556

(22) PCT Filed: Apr. 27, 2010
(86) PCT No.: PCT/RU10/00208

§ 371 Date: Nov. 8, 2012

(51) Int. Cl. C09K 8/80; E21B 43/22

(52) U.S. Cl. 166/280.2

(57) ABSTRACT

A method is given for heterogeneous proppant placement in fracturing by in situ aggregation of fine mesh proppant particulates or other materials such as fibers in a subterranean fracture. A polymer is injected into a subterranean formation and is subsequently subjected to a chemical reaction, for example hydrolysis, under downhole conditions, which leads to formation of either a cationic or an anionic polyelectrolyte. Alternatively, the polyelectrolyte is synthesized downhole by, for example, a Hofmann degradation or a Mannich reaction. The polyelectrolyte acts as a flocculant and provides aggregation of solid particulates such as sand, mica, silica flour, ceramics and the like, which leads to formation of proppant micropillars deep in the fracture. Methods of aggregation of fibers to enhance bridging, and other applications of controlled flocculation are also given.

### BACKGROUND OF THE INVENTION

This invention relates to hydraulic fracturing. More particularly, the invention is related to chemical transformations of hydraulic fracturing materials under downhole conditions (in-situ) to provide control over stimulation processes.

Among methods of fracture conductivity enhancement, heterogeneous proppant placement (HPP) is especially attractive. Various methods of heterogeneous proppant placement have been developed. Placement of clusters (for example pillars or islands), made with proppant consolidated by various techniques provides large open channels in the fracture and conductivities higher than that of conventionally propped fractures by orders of magnitude. The vast majority of HPP methods rely on consolidation of conventional proppant particulates (>about 0.42 mm (about 40 US mesh) in diameter) by means of fibers, tackifying or sticky materials, binder fluids etc., leading to formation of proppant clusters. Reliable methods of delivery of such clusters downhole is one of the challenges of the HPP methods. While generally not applicable for conventional proppants, flocculation can be used to aggregate fine mesh proppant particulates with diameters of tens to about a hundred microns (smaller than about 100 US mesh). In such cases the forces required to consolidate the proppant cluster are much smaller. It has been shown that the conductivity of proppant packs made of fine mesh particulates is very low; however, the advantage of fine mesh proppants is their good transport properties, as these particulates can be delivered far from a wellbore and deep into a fracture network with an inexpensive fluid of low viscosity (e.g. slick water), without the settling issues inherent in using conventional proppants. There is a need for a method of enhancing the conductivity of fine mesh packs; the resulting proppant/fluid system has great utility, especially in unconventional reservoirs with extremely low matrix permeabilities, such as gas shales.

### SUMMARY OF THE INVENTION

One embodiment of the invention is a method for synthesizing a polyelectrolyte in a treatment fluid in a subterranean location involving the steps of injecting the treatment fluid containing a polymeric precursor of the polyelectrolyte into a wellbore, and allowing the polyelectrolyte to form. The treatment fluid may contain a proppant, and optionally a fine-meshed proppant. The treatment fluid may also contain one or more than one of a fiber, a viscosifying agent, an adhesive, a reinforcing material, an emulsion, an energizing or foaming gas, and/or a hydrolysable solid acid.

The polyelectrolyte may be formed from the polymeric precursor by hydrolysis of chemical groups on the polymer, by protonation of chemical groups on the polymer, or by conversion of chemical groups on the polymer to salts.

In another embodiment, the polyelectrolyte forms from the polymeric precursor by reaction of an amide function on the polymeric precursor with one or more reagents in the treatment fluid. The treatment fluid may further contain a catalyst or a retarder for the formation of the polyelectrolyte from the polymeric precursor, and/or an agent for changing the treatment fluid pH under subterranean conditions.

In yet another embodiment, the polymeric precursor contains an amide group and the treatment fluid contains an aldehyde or aldehyde precursor and a compound having a labile proton (for example selected from ammonia, a primary amine, a secondary amine, a hydrazine, a hydroxylamine, a polyamine, and/or any of these amines further having a permanently charged group). Examples of compounds having a labile proton include a sulfomethylation agent, a malonic acid and a phenol.

In other embodiments, the treatment fluid may also contain a secondary amine, and the polymeric precursor may include an amide group and the treatment fluid may contain a hypohalite or a tetraacetate, an ethylene oxide derivative having a polar group, or a glyoxylic acid.

### BRIEF DESCRIPTION OF THE DRAWINGS

FIG. 1 shows the effect of pH on the amine group yield in the Mannich reaction.

FIG. 2 shows the effect of the reagent ratio on the yield of amine groups in the Mannich reaction.

FIG. 3 shows amine concentrations (“yields) of Mannich reactions with different amines.

FIG. 4 shows the crosslinking time for the Mannich reaction with varying amine/formaldehyde ratio.

FIG. 5 shows yields of the Hofmann degradation reaction with sodium hypochlorite as a function of temperature.

### DETAILED DESCRIPTION OF THE INVENTION

Although the invention may be described primarily as a method of aggregating fine mesh proppant as a means for producing heterogeneous proppant placement in hydraulic fracturing, the invention has many other uses. Although the invention may be described in terms of treatment of vertical wells, it is equally applicable to wells of any orientation. The invention will be described for hydrocarbon production wells, but it is to be understood that the invention may be used for wells for production of other fluids, such as water or carbon dioxide, or, for example, for injection or storage wells. It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the inventors appreciate and understand that any and all data points within the range are to be considered to have been specified, and that the inventors have possession of the entire range and all points within the range.

The primary utility of the method of the present invention is a method of in situ aggregation of proppant particulates, for example fine mesh proppant particulates if the proppant is to be flocculated, or other materials such as fibers in a subterranean fracture. In one such use of the invention, a polyacrylamide polymer is injected into a subterranean formation during the hydraulic fracturing treatment. The polymer subsequently is subjected to a chemical reaction, for example hydrolysis, under downhole conditions, which leads to formation of either a cationic or an anionic polyelectrolyte. The polyelectrolyte acts as a flocculant and provides aggregation of solid particulates such as sand, mica, silica flour, ceramics and the like, which leads to formation of fluid flow channels in the proppant pack, or proppant micropillars deep in the fracture. Aggregation of fibers to enhance bridging, and other applications of controlled flocculation are also useful.

This use is most effective in low permeability formations and with fine-meshed proppant materials. As used herein, the term “low-permeability formation” refers to formations having permeabilities less than 1 millidarcy, for example less than 100 microdarcy. These formations have such low permeability that the wells can be effectively stimulated when the final primary fracture conductivity is on the order of 0.3 to 30 mD-m (1 to 100 mD-ft) and, if present, the secondary and/or tertiary fractures are on the order of 0.003 to 30 mD-m (0.01 to 100 mD-ft), where secondary fractures are understood to refer to usually relatively smaller fractures in length and/or width branching from the primary fractures, and tertiary fractures to usually relatively smaller fractures in length and/or width branching from the secondary fractures. As used herein the term “fine mesh materials” refers to proppant materials having a relatively smaller grain size than the smallest proppant size of 70/140 (sieve openings of 210 and 105 micron) defined by American Petroleum Institute Recommended Practices (API RP) standards 56 and/or 60. These standards require that at least 90 weight percent of the particles pass the sieve of size 70 which defines an upper boundary but are retained on a sieve of size 140 which defines the lower boundary. The full specification for 70/140 sand requires that not more than 0.1 weight percent is retained on a 50 mesh (300 micron) sieve, 90 weight percent passes 70 mesh but is retained on 140 mesh and not more than 1 weight percent passes a 200 mesh (75 micron) sieve. All mesh sizes provided herein refer to the mesh size as measured using the US Sieve Series unless otherwise stated.

In one embodiment, the injected treatment fluid is essentially free of proppant and/or other solids larger than fine mesh materials, e.g., to the extent that the larger materials do not adversely impact the ability of the flocculant to form proppant aggregates. In another embodiment, the treatment fluid does not contain any larger materials that are deliberately added to the treatment fluid or proppant material. In other embodiments, the injected treatment fluid can contain a relatively small proportion of solids that are larger than the fine mesh materials, such as for example, less than about 10 weight percent. In yet another embodiment, the proportion of solids that are larger than fine mesh solids may be substantial, for example up to about 60 to 70 weight percent, for example when the solids are a mixture of different sizes specially designed to pack well into a volume.

Proppant used in this application may not necessarily require the same permeability and conductivity properties as typically required in conventional treatments, because the overall fracture permeability is at least partially developed from formation open channels in the proppant pack. The roundness and/or sphericity may be less than normally preferred. In fact, the proppant material can be of other shapes such as cubic, rectangular, plate-like, rod-like, or mixtures thereof.

Suitable fine mesh proppant materials can include sand, glass beads, ceramics, bauxites, glass, and the like or mixtures thereof. In one embodiment, the fine mesh proppant material can be selected from silica, muscovite, biotite, limestone, Portland cement, talc, kaolin, barite, fly ash, pozzolan, alumina, zirconia, titanium oxide, zeolite, graphite, plastic beads such as styrene divinylbenzene, particulate metals, natural materials such as crushed shells, carbon black, aluminosilicates, biopolymer solids, synthetic polymer solids, mica, and the like, including mixtures thereof. Essentially, the proppant can be any fine mesh material that will hold open the propped portion of the fracture.

Heterogeneous proppant placement relaxes some constraints on the choice of proppant material because flow conductivity is provided by channels between ‘islands’ or pillars of proppant rather than by the porosity or permeability of the packed proppant matrix. The availability of the option to select a wider range of proppant materials can be an advantage in embodiments of the present invention. For example, proppant can have a range of mixed, variable diameters or other properties that yield an island or pillar of high-density and/or high-strength, but low permeability and/or porosity because porosity and permeability are not so important because fluid production through the proppant matrix is not required. For the same reason, an adhesive, as is well known in the art of fracturing, or a reinforcing material that would plug a conventional proppant pack can be employed in the interstitial spaces of the fine mesh proppant matrix herein, such as, for example, a polymer which can be further polymerized or crosslinked in the proppant.

The heterogeneous proppant placement method of the invention may be used in conjunction with any other heterogeneous proppant placement method. The treatment fluid may optionally be a slickwater fluid or a viscosified fluid, may be an emulsion or energized or foamed, and may contain fibers or hydrolysable solid acids, for example polyglycolic acid and polylactic acid. The ratio of the number of particles in a system before aggregation divided by the number of aggregates after aggregation should be at least about 2.

In another use of the invention, polymers injected into a wellbore and reacted under downhole conditions act as scale inhibitors. Charged polyacrylamide derivatives effectively suppress growth of crystals of sulfides, carbonates, and sulfates of various metals, such as magnesium, calcium, barium, zinc, iron and others.

In a yet another use of the invention, polymers injected into a wellbore and reacted under downhole conditions act as relative permeability modifiers. Charged polymers adsorb on formation pore surfaces and reduce water permeability, while oil permeability remains intact or is only insignificantly decreased. Furthermore, thin layers of polymer (for example with less than 250 nm thickness) adsorbed on grains of proppant in the pack improve fracture clean-up during flowback operations with polysaccharide-based gels, and reduce gel damage to the proppant pack.

In a yet another use of the invention, polymers injected into a wellbore and reacted under downhole conditions allow improved fines control. Charged polymers adsorb onto formation surfaces and/or onto crushed proppant fines reducing the zeta potential, and thus promoting their agglomeration.

In yet another use of the invention, a polyacrylamide cross-linked via a Mannich formaldehyde-diamine system and/or by dialdehydes is used as a viscosified fracturing fluid. Control over the reaction, including cross-link delay and reaction reversal, is achieved by means of pH adjustment.

In a further use of the invention a polyacrylamide cross-linked with a formaldehyde-diamine system and/or with polyaldehydes and/or polyamines is used for water control; this is an alternative to known PAM gels cross-linked with transition metal ions (for example with undesirable chromium(III)) or with phenol-formaldehyde systems.

In one more use of the invention, formation of a polyelectrolyte with a switchable charge is achieved by in situ reaction under downhole conditions. The switch may be a change of polyelectrolyte character from cationic to anionic and vice versa (or from non-ionic to ionic and vice versa). For example, this occurs with polyacrylamides under Mannich conditions. The initial polyacrylamide contains some carboxylate groups, thus exhibiting anionic character. Conversion by the Mannich reaction into the polyamine converts the polymer to cationic due to amine group protonation. Another example is hydrolysis of a polyacrylamide, which forms negatively charged carboxylate groups from neutral amide groups. The controllable polymer charge allows management of flocculation. Having a polyelectrolyte of a certain charge (for example, positive) downhole and then partially changing the charge to negative (e.g., by hydrolysis) results in chemically controlled flocculation. De-flocculation is also possible via a similar charge switch, when polyelectrolytes having opposite charges are converted into polyelectrolytes having the same charge.

Suitable polymers and copolymers that produce polyelectrolytes upon hydrolysis or protonation include, but are not limited to, those having at least one monomer selected from acrylamide, methacrylamide, N-vinylmethylacetamide, N-vinylmethylformamide, vinyl acetate, acrylate esters, methacrylate esters, cyanoacrylates, vinyl pyrrolidones, aniline, aminoacids, ketones, urethanes, ureas, melamines, and the like, and combinations and mixtures thereof. The resulting polyelectrolytes include, but are not limited to, polyethyleneamines, polyethyleneimines, and polyvinylamines;

Polyacrylamide polymers (PAMs) are used extensively in oilfield technologies, for example in drilling and cementing fluids, in enhanced oil recovery formulations, in water control gels, and as additives for friction reduction. Polyacrylamide and some monomeric units in commonly used copolymers are shown below (in polymerized form):

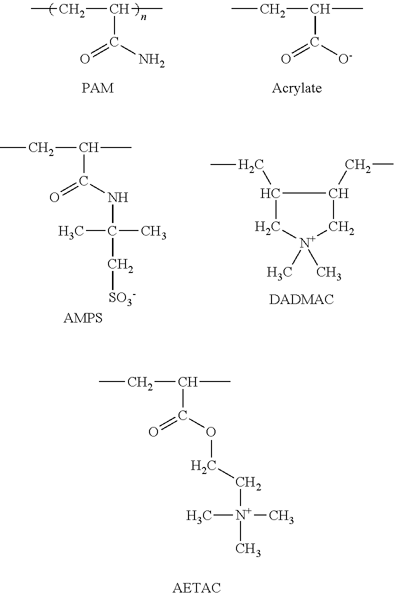

The most important anionic monomers are acrylate (acrylic acid) methacrylates (methacrylic acid), polyisobutyl methacrylate, ethylenesulfonic acid, 4-styrenesulfonic acid, 2-methyl-2-[(I-oxo-2-propenyl)amino]-I-propanesulfonic acid, and acrylamido-2-methyl-1-propane sulfonic acid (AMPS). The most important cationic monomers include diallyldimethylammonium chloride (DADMAC), and acryloyloxyethyltrimethylammonium chloride (AETAC). Other suitable cationic polymeric flocculants can include polymers (protonated when necessary) that include monomers and/or comonomers such as substituted acrylamide and methacrylamide salts, for example, methacrylamidopropyltrimethylammonium chloride, methacryloyloxyethyltrimethylammonium chloride and N,N-dimethylaminoethyl methacrylate, N-vinylformamide and N-vinylacetamide which are hydrolyzed in alkaline or acid to vinylamine copolymers, salts of N-vinylimidazole, 2-vinylpyridine, 4-vinylpyridine, dialkyldiallylammonium chlorides (e.g., diallyldimethylammonium chloride), and the like. Polyamines, e.g., prepared by polycondensation of alkylene dichlorides or epichlorohydrin and ammonia, low molecular weight alkylene polyamines, or polyaminoamides

Monomers leading to cationic copolymers are generally expensive; however, preparation of cationic PAMs can be achieved without copolymerization that requires expensive cationic monomers. The Mannich reaction, which involves condensation of an amine, an aldehyde, usually formaldehyde, and a compound having a labile proton, may be used for polyacrylamide synthesis. The Mannich-type aminomethylation of PAM with formaldehyde and a secondary amine leads to formation of a carbamoyl polymer, as shown in reaction (1) below:

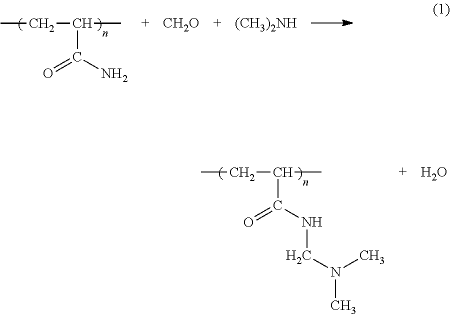

This reaction is normally carried out in an aqueous solution at a low polymer concentration and high pH; it is reversible and pH dependent, as the rate of substitution at low pH is very slow. The conversion time at 80° C. is commonly about 15 minutes; the rate increases with increasing temperature. Thus the rate and extent of reaction can be controlled at a given temperature by pH. This makes this reaction very suitable for downhole conversions. Generally not only secondary, but also primary amines and ammonia can undergo transformations similar to reaction 1. However, with primary amines, reaction yields are less predictable because the initially formed secondary Mannich base can react further to give a tertiary amine. The use of ammonia for the synthesis of primary Mannich bases is more complicated because of products derived from multiple substitution. Nevertheless, all Mannich bases obtained by means of aminomethylation of PAM provide cationic polyelectrolytes useful in the invention. For example, U.S. Pat. No. 4,179,424 discloses a process for rapidly preparing amino methylated derivatives (and their quaternanry ammonium salts) of dilute aqueous solutions of acrylamide polymers.

The resulting PAMs in aqueous solution have cationic charges due to protonation of the Mannich base groups. The polymer charge densities are controlled by chemical means (for example by the concentrations and ratios of the reagents in the reaction mixtures) and by tuning the pH of the resulting Mannich PAM solutions. Alternatively, aminomethylated groups of the PAM polymers are converted further to quaternary ammonium salts by treatment with quaternizing agents such as dimethyl sulfate or methyl halogenites.

The simplicity of the manufacturing process makes Mannich-derived PAMs quite attractive for water treatment, but these PAMs have several disadvantages. First, the achievable polymer concentrations in solution usually do not exceed about 6 percent of solids; otherwise the solution viscosity becomes too high. This introduces the added expense of shipping low-solids formulations. Second, Mannich-derived PAMs tend to gel over time, due to polymer cross-linking with formaldehyde. These disadvantages limit the application of Mannich PAMs in water treatment. However, these limitations of the Mannich reaction with PAMs are not problems in the in situ (subterranean) method of the present invention.

Another known method of modification of PAMs to incorporate cationic groups is the Hofmann degradation reaction. PAMs react with hypohalites (hypohalogenites) in alkaline solution to form a polymer having primary amine groups as shown below in reaction (2):

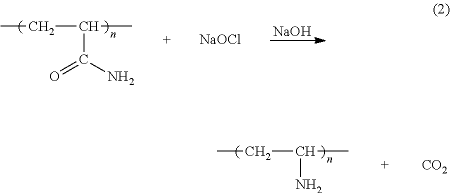

For example, cationic acrylamide polymers are formed after subsequent protonation by the reactions, with a hypohalogenite, of a (meth)acrylamide homopolymer, or a copolymer of (meth)acrylamide and acrylonitrile, or a copolymer of (meth)acrylamide and N,N-dimethylacrylamide, in the temperature range of about 50 to about 110° C. The reactions are slower at lower temperatures; at higher temperatures there may be polymer degradation.

Direct incorporation of anionic groups into PAMs is also an available route to downhole synthesis. The hydrolysis of PAMs takes place at high pH and the polymer in aqueous solution often contains a portion of acrylic groups. Other methods of anionic PAMs synthesis are also available, for example sulfomethylation, as shown below in reaction (3):

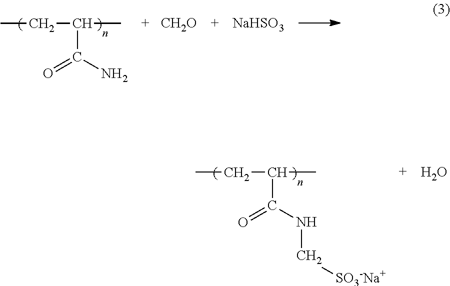

The reaction of PAM with formaldehyde and bisulfate takes place at pH less than about 12 and temperatures above about 100° C. These anionic PAMs made by in situ sulfomethylation are useful as anionic flocculants (for example for aggregating particles having positive surface charges, such as cement particulates, metal oxides and halides etc.). Furthermore, sulfomethylated PAMs can be cross-linked with a variety of metal ion cross-linkers, giving highly viscous gels, which may also be used in oilfield technology.

### Heterogeneous Proppant Placement

The use of polymers, including polyelectrolytes, as flocculants downhole to agglomerate fine-meshed proppants to cause heterogeneous proppant placement is known; however, in the past such flocculants have been synthesized before injection. Therefore it has been necessary to keep the flocculant and the fine mesh proppant separate until flocculation is desired. This can been be done, for example, by injecting the proppant and the flocculant separately (for example one in coiled tubing and one in the annulus around the coiled tubing) or by keeping them separate within a single well treatment fluid such as a slurry (for example by use of an emulsion or encapsulation to isolate one or both components). The downhole flocculant synthesis of the present invention makes separation of the proppant and the flocculant unnecessary. The flocculant is not present in the proppant slurry as injected.

### Scale Inhibitors

Co-polymers of polyacrylamide with cationic or anionic monomers, either optionally also with non-ionic monomers, have been shown to be effective scale inhibitors, which effectively inhibit and control formation of inorganic scales with particular application to the removal of zinc sulfide and iron sulfide scales formed when zinc bromide brines are used as completion fluids.

The unifying concept of the present invention is generation of polyelectrolytes such as polyacrylamide (PAM) under downhole conditions by means of a chemical transformation of a precursor of the polyelectrolyte. Such a transformation leads to drastic changes in the polymer properties, for example the polymer conformation, due to electrostatic interactions within the polymer. If the polymer is in a proppant carrier fluid in a fracture, then a suitable polymer transformation results in aggregation of proppant particulates in a fracture.

The following chemical reactions are most often used for PAM polyelectrolyte formation in situ:
1. Hydrolysis: (RCONH₂→RCOOH)
2. Mannich-like reactions: (polyacrylamide+RCHO+YH→polymer−RCH−Y, where YH is a compound having a mobile hydrogen ion; the mobile hydrogen ion may be attached to a C, N, P, S, or O atom; RCHO is any aldehyde or its derivative/precursor)
3. Hoffman reaction: (RCONH₂→RNH₂)
4. Alkylation: (RCONH₂+ethylene oxide derivative with polar group→RCONHR′ or RCONR′₂)

### Hydrolysis

Polyamide hydrolysis is a well-known reaction. In aqueous solution the rate of hydrolysis depends upon polymer concentration, pH and temperature. As a result, a portion of the amide groups of PAM are converted into carboxylic groups having a negative charge, leading to a change in the polymer conformation. Thus, to trigger polyelectrolyte formation downhole, basic additives (as examples calcium, magnesium, or zinc oxides, hydroxides, or carbonates, and sodium hydroxide and others known to those skilled in the art) may be added. The pH change may be delayed, for example by using a slowly-soluble base. Also, proppants having basic groups on their surface can enhance PAM hydrolysis. Partially hydrolyzed PAM acts as a flocculant for fine mesh solid particulates having positive surface charges.

### Mannich-Like Reactions

The Mannich reaction (reaction 1 above) leads to formation of a tertiary amine, which in aqueous solution can be protonated even with water and, thus, can hold a positive charge. This reaction is applicable to various polyacrylamides, which can be converted to their Mannich PAMs by treatment with formaldehyde (optionally obtained from a formaldehyde precursor) and a dialkylamine. The resulting cationic polyelectrolyte acts as a flocculant towards particulates having negative surface charges. This process is used in waste water treatment; however, flocculants based on the Mannich amines have certain disadvantages, such as low polymer solubility and gelling over time. Formation of Mannich PAMs in situ allows the operator to overcome some of these limitations.

Polyacrylamide polymers are widely used in the oilfield; therefore the industry has accumulated experience in dealing with these and similar compounds. In contrast, formaldehyde is rarely used as it is a very dangerous chemical. Formaldehyde, as well as its aqueous solutions, can be toxic, allergenic and carcinogenic, so it is a subject of serious health, safety and environmental concerns. However, formaldehyde can be produced safely in situ by hydrolysis of relatively safe compounds, for example hexamine (also known as hexamethylenetetramine, or urotropine), paraformaldehyde, 1,3,5-trioxane, glyoxal and the like, which release formaldehyde when heated, are shown below:

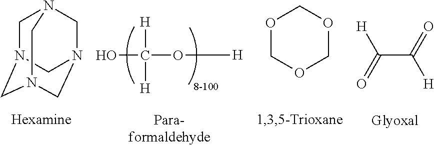

Some additional formaldehyde derivatives that may be used instead of formaldehyde are as follows:

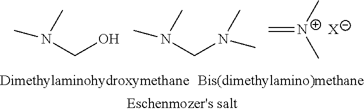

Once the formaldehyde is formed and a dialkylamine is available in solution, the Mannich reaction is initiated, giving the Mannich tertiary amines. The elevated pH required for the reaction to proceed can be produced either on the surface with alkali or by means of various delayed pH agents (for example the slow dissolution of magnesia). While secondary amines can also increase the fluid pH, their use is limited, as surface delivery of these chemicals is likely in the form of their hydrochloride salts. Aminomethylation with ammonia, derived from the hydrolysis of urotropine is another, even a simpler, way of flocculant formation.

The Mannich amine, obtained as in reaction 1, is a strong base, so it remains protonated even at relatively high pH values. Because elevated pH leads to an increased negative charge on the surface of siliceous materials, the flocculation process is facilitated. Formation of proppant flocs/clusters just before fracture closure provides open channels in the pack and, therefore, enhanced fracture conductivity. As the Mannich PAMs tend to gel over time, consolidation of the proppant particulates in the clusters will further strengthen with time. If necessary, the Mannich reaction can be reversed by decreasing the pH, which can be achieved by degradation of a variety of slowly hydrolysable acid-releasing organic compounds, for example polylactic acid (PLA) or other polyesters.

Crosslinked PAMs are well known as water control gels. Crosslinkers are typically released downhole. Formaldehyde/phenol crosslinking is common. For example, urotropine hydrolyzes under downhole conditions releasing formaldehyde, and phenol is released downhole by hydrolysis of phenyl acetate. The resulted binary cross-linking system allows fast bonding of polyacrylamide polymer chains, giving highly viscous gels, which allows sealing of water producing fissures. Other cross-linking systems for PAM polymers are available, for example Cr⁺⁺⁺, aluminum citrate, polyethyleneimine and others. Performing the Mannich reaction downhole in the presence of polyamines, for example polydiamines, provides covalent cross-linking of PAMs and can be used in water control systems. A suitable polyamine is tetraethylenepentamine, which can be used instead of secondary amines in the Mannich reaction. Any of these forms of crosslinking are useful to change the PAM conformation and cause proppant aggregation in the present invention.

In general, various aldehydes and amines containing charged groups (for example quaternary ammonium groups) can be used for downhole PAM Mannich transformations.

Hydrazine, hydroxylamine and their derivatives may also be used in Mannich reactions in ways similar to amines. For example, Girard's reagent, shown below, may be used as an amine compound holding a permanently positively charged group.

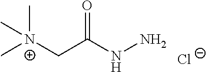

Pumping PAM, formaldehyde or a derivative or precursor, and malonic acid leads to amide modification with two carboxylic groups; one of them can be removed by a decarboxylation reaction following the Mannich transformation (here, as in other structures below, the sphere represents a polymer):

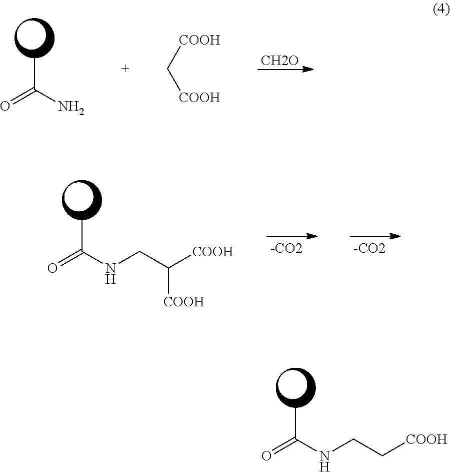

Although phenol is a weak acid (pK ˜10), the phenolate anion formed in basic media easily reacts with formaldehyde and is thus attached to the amide function of PAMs. An amine component is then added and the combined modification leads to a switchable polyelectrolyte, as shown below in reaction 5, which is positively charged in neutral or acidic media, and negatively charged in basic media. Formation of switchable polyelectrolytes allows control of flocculation in a fracture by changing the fluid pH. Aminomethylated phenols are also useful as a phenolic component for in situ formation of switchable polyelectrolytes.

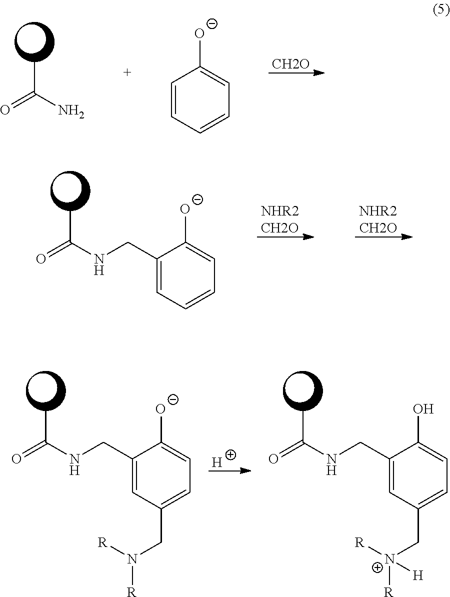

These types of reactions with polyamides and formaldehyde work with any additional component having a labile H; non-limiting examples in addition to those described above include amides, thiols, ureas, guanidines, urethanes, melamine, aminoacids, benzoic acid and phenols. These either lead directly to charged polymers or to polymers that can be converted to charged polymers.

### Hoffman Degradation

Utilization of the Hofmann degradation of PAM, as was shown in reaction (2) above, is another way of incorporating cationic groups into polymer backbones. Conversion of PAM to primary amines or their derivatives is done with alkaline hypohalites or a combination of halogen and alkaline hydroxides in aqueous solutions with heating. The reaction may also proceed under mildly acidic conditions with other oxidants, for example lead tetraacetate. Note, however, that at temperatures above about 50° C. the polymer may be subject to chain scission with a consequent molecular weight decrease. Similar to Mannich bases, Hofmann polyvinylamines are efficient flocculants and are useful for heterogeneous placement of fine mesh proppants.

### Alkylation

Amides may be alkylated with ethylene oxide derivatives. Ethylene oxide or longer epoxide derivatives having polar groups may be use to modify PAM downhole. For example, under bottomhole conditions PAM modified with glycidyltrimethylammonium chloride gives a tertiary ammonium derivative, as shown below in reaction 6.

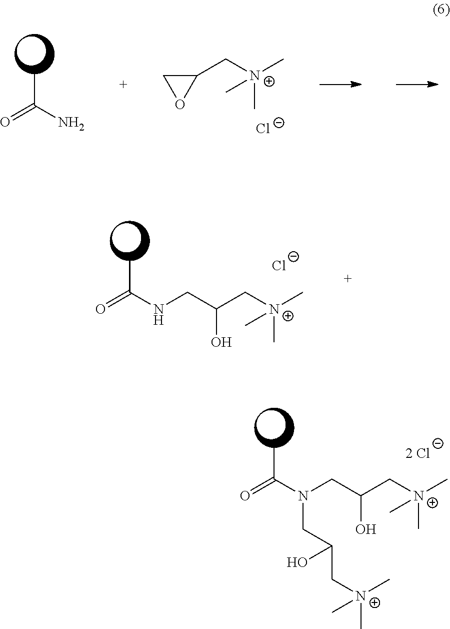

Catalyst-free alkylation of acrylamide at low pH with glyoxylic acid or other carboxylic acids with one or more aldehyde groups gives acrylamide modified with carboxylic groups. Modifying PAM under downhole conditions with the same reagent leads to polymer flocculation.

The preferred concentration range of particles to be flocculated is from about 0.1 to about 70 weight percent; the preferred concentration range of flocculant is from about 0.1 to about 10 weight percent. For plate-like particles such as mica, the concentration in the slurry is preferably from about 0.0012 to about 2.4 kg/L, more preferably from about 0.0012 to about 0.06 kg/L.
The present invention can be further understood from the following examples.

### Reagents

Two commercially available polyacrylamide polymers were tested: one having an average molecular weight of about 500 kDa (1 kDa=1000 MW) and a degree of hydrolysis of about 5 percent (polymer A), and one having an average molecular weight of about 3 MDa and a degree of hydrolysis of about 0.5 percent (polymer B). Aqueous ammonia was used as a 35 percent solution, sodium hypochlorite (NaOCl) as a 10 percent solution, and CaOCl₂ as an approximately 20 percent solution. CelluSep H1™ regenerated cellulose membranes with a molecular weight cut-off of about 1 kDa were obtained from Medigen (Novosibirsk, Russia) for use in dialysis of polymer products.

### General Procedures

### Mannich Reaction

Aqueous solutions of polymer (25 ml) were mixed with a given volume of 35 percent aqueous ammonia and the pH of the mixture was adjusted to the required value with 4 percent acetic acid. After the mixture was heated to the selected temperature, paraformaldehyde was added under intensive stirring, and heating with a reflux condenser was continued for a selected period of time. After the reaction mixture was cooled down to room temperature, the polymer product was isolated by dialysis for 4 hr in 3 to 5 portions of deionized water (6 L in total). The solvent (water) was then evaporated at 50° C. using a rotovap.

### Hofmann Degradation

1 weight percent of polymer solution was mixed with either 7 ml of 10 percent sodium hypochlorite (NaOCl) solution or 2.5 g of CaOCl₂ and heated for 2 hr with a reflux condenser. Polymer product isolation was done by dialysis as described above.

### Polymer Product Characterization

A weighed amount of dry polymer was dissolved in deionized water and titrated for amine groups with hydrochloric acid, using a pH glass electrode for end point detection. The reaction yield was calculated as the percentage of amine groups relative to the amount of amide groups in the original polymer. Original polymers and selected polymer products were also characterized by ¹H NMR and IR spectroscopies, CHN analysis and GPC; the results are given in Table 1 below.

### Example 1

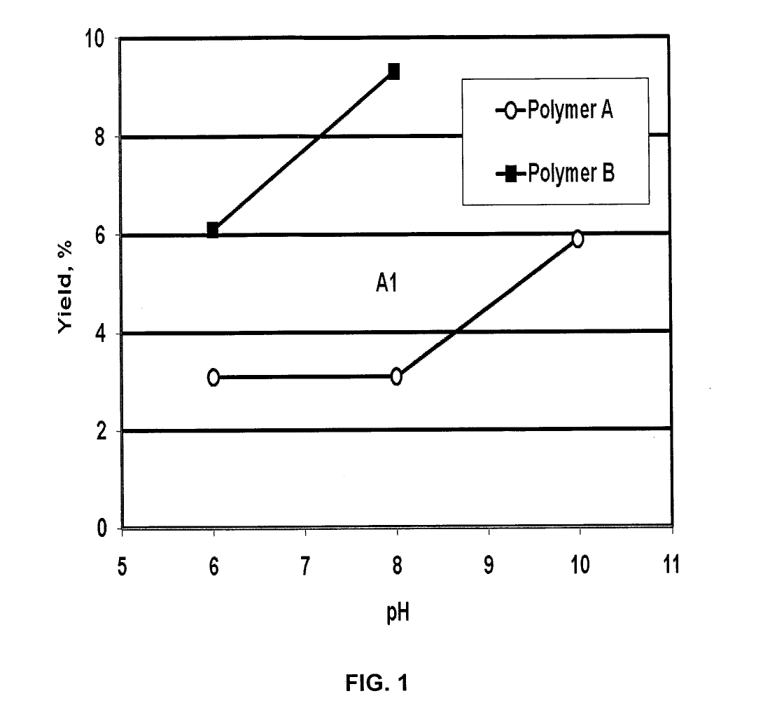

The effect of pH in the range of about 6 to 10 on the Mannich reaction was investigated; the results are summarized in FIG. 1. The concentrations of polymers A and B were 5.0 and 3.3 weight percent, respectively. 3.5 ml of aqueous ammonia and 2.0 g of paraformaldehyde were added. The reaction temperature was 100° C. and the reaction time was 10 min. The yield of amine groups increased with an increase of pH; the optimal pH found for the reaction is above 8. The average molecular weight of the polymer decreased in the reaction (see Table 1, in which original polymer A is compared to polymer A1).

### Example 2

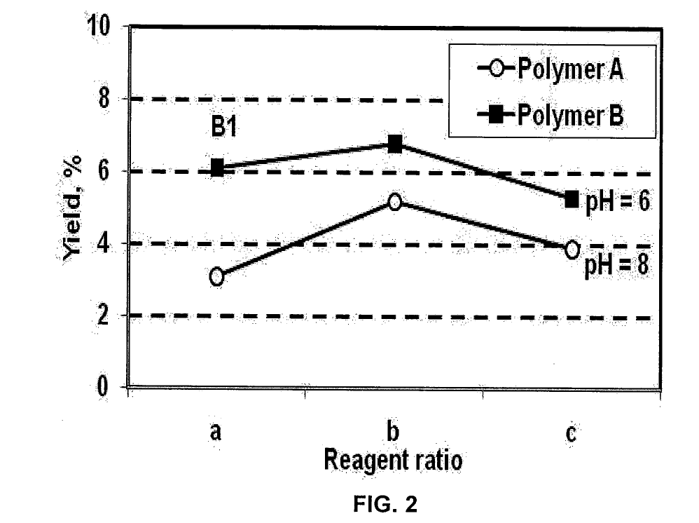

The effect of the reagent ratio on the Mannich reaction was analyzed by adding either equimolar quantities or an excess of either ammonia or paraformaldehyde relative to the amount of amide groups in the original polymer. The reaction was carried at 100° C., (a) corresponds to 3.5 ml of aqueous ammonia and 2 g of paraformaldehyde (an equimolar ratio); (b) corresponds to 5 ml of aqueous ammonia and 2 g of paraformaldehyde; and (c) corresponds to 3.5 ml of aqueous ammonia and 3 g of paraformaldehyde. An excess of amine increased the yield of amine groups at both pH values, as shown in FIG. 2. Polymers B and B1 are characterized in Table 1.

### Example 3

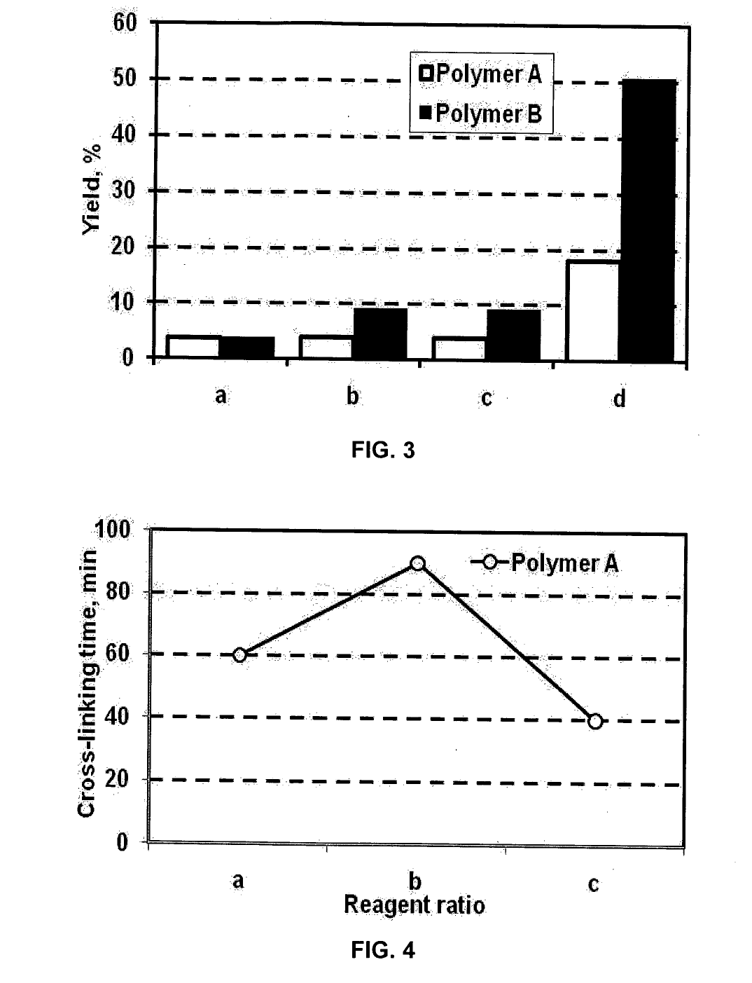

Amines other than ammonia: (a) guanidine; (b) aminoguanidine; (c) hexamine; (d) tetraethylenepentamine (TEPA) were tested in the Mannich reaction, as shown in FIG. 3. The polymer concentrations were 1 weight percent; the reactions were performed at 100° C. for 30 min. The resulting polymers had higher amine group contents, especially the product of aminomethylation with TEPA.

### Example 4

Crosslinking of polyacrylamide by aminomethylene groups was observed with polymer A at 5 weight percent PAM if the reaction was carried out for more than 40 min at 100° C. It was found that the viscosity of the mixture increases with time, resulting in solution gelling. The crosslinking time was found to depend on the reagent ratio, as shown in FIG. 4 ((a) equimolar reagent ratio; (b) excess of amine; (c) excess of formaldehyde). The crosslinking time was longer when amine was present in excess; in the absence of amine the gelling did not occur at all. Not to be limited by theory, but we believe that the Mannich reaction leads to formation of —NH—CH₂—NH— linkages between two polyacrylamide polymer chains. The polymer solutions with a lower concentration (e.g. 0.5 weight percent) did not show any viscosity changes after the Mannich reaction was carried out for 120 min.

### Example 5

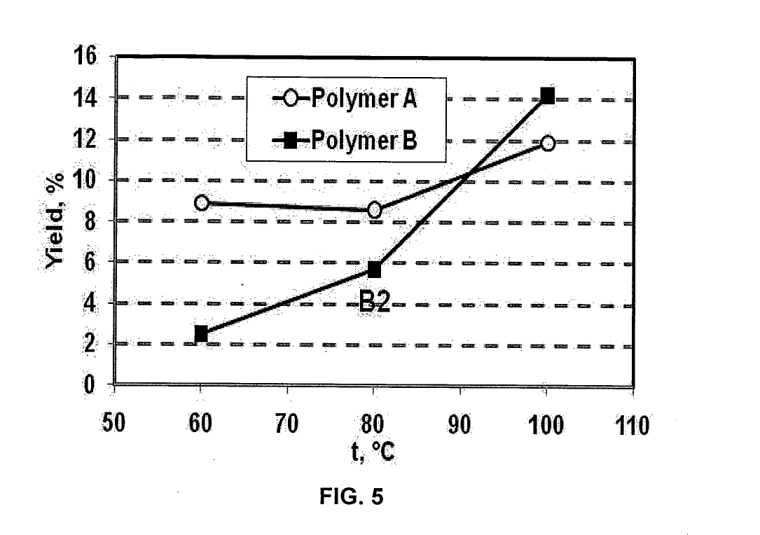

The effect of temperature on the amine group yield in the Hofmann degradation reaction was studied; the results are given in FIG. 5. In general, the yields of amino groups in this reaction were higher than those of the Mannich reaction. However, oxidative polymer cleavage took place, leading to significantly lower molecular weights of the polymer products. Thus, a product from polymer B had a molecular weight more than 10 times lower than that of the original polymer, as shown in Table 1 comparing polymers B and B1 of FIG. 5. Similar results were obtained in reactions with CaOCl₂.

### Example 6

A solution of the Mannich reaction product, polymer B1, was diluted by a factor of 10 to give an approximately 0.5 weight percent polymer solution. This solution was mixed with the same volume of an 0.25 weight percent aqueous solution of polyacrylic acid (average M_{w} 450 kDa), and hand shaken for about 3 min. A white thin net first appeared in the mixture, which then grew to form a white and soft clot of a polyelectrolyte complex of the Mannich polycation and the polyacrylic acid. The complex was found to be insoluble in dilute hydrochloric acid and in sodium hydroxide at room temperature after soaking for 30 min. Similar precipitates were formed in diluted solutions of polymer A1 (a Mannich polycation) and polymer B2 (a Hofmann polycation), mixed with polyacrylic acid. Solutions of initial polymers A and B did not form polyelectrolyte complexes under similar conditions.

### Example 7

A homogeneous dispersion of 2 g of silica flour (from U.S. Silica, USA), having particle sizes less than 44 microns (325 US mesh), in 1 ml of deionized water had a milky appearance; it was added to 0.5 weight percent solutions of the Mannich (A1, B1) and Hofmann (B2) polymers. Vessels containing the mixtures were vigorously shaken for 2 min and the resulting dispersions were left on a flat laboratory bench surface. Complete settling of silica particles was achieved in less than two minutes in all samples, giving almost transparent solutions above the precipitate. The settled silica was found to be agglomerated in lumps of about 0.5 to 1 mm in size, due to flocculation by the polycationic polymers. Similar tests with non-reacted polyacrylamides were performed, and settling of silica took more than 15 min, after which the solutions were turbid.

TABLE 1

| | | | CHN analysis | | | |
|---|---|---|---|---|---|---|
| | | | per | per | per | M_{w} |
| Poly- | ¹H NMR δ, | | cent | cent | cent | range, |
| mer | ppm | IR, cm⁻¹ | C | H | N | kDa |
| A | 1.18 t; 1.6 d; | 1661 (C═O | 44.99 | 7.20 | 16.78 | 430-560 |
| | 1.94 s; 2.2 t; | amide), 1580 | | | | |
| | 3.35 s; 3.66 q; | (COO⁻), 1621 | | | | |
| | 6.9 m; 7.8 m | (NH amide), | | | | |
| | | 3435, 3200 (NH | | | | |
| | | amide) | | | | |
| B | 1.18 t; 1.5 m; | 1659, 1644 (C═O | 40.80 | 6.47 | 8.62 | 2660- |
| | 2.1 m; 3.35 s; | amide), 1549 (NH | | | | 3050 |
| | 3.65 q | amide), 3441 (NH | | | | |
| | | amide) | | | | |
| A1 | 1.05 t; 1.5 d; | 1649 (C═O | 44.32 | 7.13 | 16.96 | 140-180 |
| | 1.75 s; 2.1 t; | amide), 1580 | | | | |
| | 3.2 s; 3.5 q; | (COO⁻), 1606 | | | | |
| | | (NH amide), | | | | |
| | | 3327, 3184 (NH | | | | |
| | | amide, amine) | | | | |
| B1 | 1.18 t; 1.5 m; | 1647 (C═O | 42.86 | 7.10 | 11.85 | 420-460 |
| | 1.9 s; 3.35 s; | amide), 1548 (NH | | | | |
| | 3.65 q | amide), 3338 (NH | | | | |
| | | amine, amine) | | | | |
| B2 | 1.18 t; 1.5 m; | 1647 (C═O | 41.33 | 6.50 | 8.90 | 19-20 |
| | 1.9 m; 2.35 | amide), 1546 (NH | | | | |
| | m; 3.25 s; | amide), 3338 (NH | | | | |
| | 3.55 q; 8.34 s | amide, amine) | | | | |

NMR notations are standard; δ is the chemical shift, referenced against TMS
(tetramethylsilane) in ppm, which is parts per million, s is singlet, d is doublet,
t is triplet, q is quadruplet and m is multiplet.

Having thus described our invention, we claim:

1. A method for synthesizing a polyelectrolyte in a treatment fluid in a subterranean location comprising the steps of (a) injecting the treatment fluid comprising a polymeric precursor of the polyelectrolyte into a wellbore, and (b) allowing the polyelectrolyte to form.

2. The method of claim 1 wherein the treatment fluid further comprises a proppant.

3. The method of claim 1 wherein the treatment fluid further comprises a fine-meshed proppant.

4. The method of claim 1 wherein the treatment fluid further comprises one or more than one of a fiber, viscosifying agent, adhesive, reinforcing material, emulsion, energizing or foaming gas, and hydrolysable solid acid.

5. The method of claim 1 wherein the polyelectrolyte forms from the polymeric precursor by hydrolysis of chemical groups on the polymer.

6. The method of claim 1 wherein the polyelectrolyte forms from the polymeric precursor by protonation of chemical groups on the polymer.

7. The method of claim 1 wherein the polyelectrolyte forms from the polymeric precursor by conversion of chemical groups on the polymer to salts.

8. The method of claim 1 wherein the polyelectrolyte forms from the polymeric precursor by reaction of an amide function on the polymeric precursor with one or more reagents in the treatment fluid.

9. The method of claim 1 wherein the treatment fluid further contains a catalyst for the formation of the polyelectrolyte from the polymeric precursor.

10. The method of claim 1 wherein the treatment fluid further contains a retarder for the formation of the polyelectrolyte from the polymeric precursor.

11. The method of claim 1 wherein the treatment fluid further contains an agent for changing the treatment fluid pH under subterranean conditions.

12. The method of claim 1 wherein the polymeric precursor comprises an amide group and the treatment fluid comprises an aldehyde or aldehyde precursor and a compound having a labile proton.

13. The method of claim 12 wherein the compound having a labile proton is selected from ammonia, a primary amine, a secondary amine, a hydrazine, a hydroxylamine, a polyamine, and any of these amines further having a permanently charged group.

14. The method of claim 12 wherein the compound having a labile proton is a sulfomethylation agent.

15. The method of claim 12 wherein the compound having a labile proton is a malonic acid.

16. The method of claim 12 wherein the compound having a labile proton is a phenol.

17. The method of claim 16 wherein the treatment fluid further contains a secondary amine.

18. The method of claim 1 wherein the polymeric precursor comprises an amide group and the treatment fluid comprises a hypohalite or a tetraacetate.

19. The method of claim 1 wherein the polymeric precursor comprises an amide group and the treatment fluid comprises an ethylene oxide derivative having a polar group.

20. The method of claim 1 wherein the polymeric precursor comprises an amide group and the treatment fluid comprises a glyoxylic acid.
